(19) United States
(12) Patent Application Publication
(10) Pub. No.: US 2006/0176247 A1
(43) Pub. Date: Aug. 10, 2006

(54) Plasma display apparatus and driving method thereof

(75) Inventors: Jong ki Kim, Gumi-si (KR); Kwang Bae Bae, Gumi-si (KR); Jae Hyun Noh, Dalseo-gu (KR); Ho Chul Jang, Nam-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/327,317

(22) Filed: Jan. 9, 2006

(30) Foreign Application Priority Data
Feb. 7, 2005 (KR) 10-2005-0011252

(51) Int. Cl. G09G 3/28

(52) U.S. Cl. 345/60

(57) ABSTRACT

A plasma display apparatus and a driving method thereof are provided. The apparatus comprises a plasma display panel comprising a plurality of sustain electrode pairs; and a sustain waveform driver comprising a filter unit provided at a path for supplying a sustain waveform to at least any one electrode of the sustain electrode pairs.

This Nonprovisional application claims priority under 35 U.S.C. § 119(a) on Patent Application No. 10-2005-0011252 filed in Korea on Feb. 7, 2005, the entire contents of which are hereby incorporated by reference.

### BACKGROUND OF THE INVENTION

1. Field of the Invention

The present invention relates to a plasma display apparatus, and more particularly, to a plasma display apparatus for preventing electromagnetic interference (EMI), and a driving method thereof.

2. Description of the Background Art

In general, in a plasma display panel, one unit cell is provided at a space between barrier ribs formed between a front panel and a rear panel. Main discharge gas such as neon (Ne), helium (He) or a mixture (He+Ne) of neon and helium and inert gas containing a small amount of xenon (Xe) are filled in each cell. When discharge is performed using high frequency voltage, the inert gas generates vacuum ultraviolet rays and phosphors provided between the barrier ribs are emitted, thereby realizing an image. The plasma display panel is attracting attention as a next generation display due to its slimness and lightweigtness.

FIG. 1 illustrates a construction of a conventional plasma display panel.

As shown in FIG. 1, a plasma display panel comprises a front substrate 100 and a rear substrate 110. The front substrate 100 has a plurality of sustain electrode pairs arranged with a scan electrode 102 and a sustain electrode 103 each paired and formed on a front glass 101, which is a display surface for displaying the image thereon. The rear substrate 110 has a plurality of address electrodes 113 arranged to intersect with the plurality of sustain electrode pairs on a rear glass 111, which is spaced apart in parallel with and sealed to the front substrate 100.

The front substrate 100 comprises the paired scan electrode 102 and the paired sustain electrode 103 for performing a mutual discharge in one pixel and sustaining emission of light, that is, the paired scan electrode 102 and the paired sustain electrode 103 each having a transparent electrode (a) formed of indium-tin-oxide (ITO) and a bus electrode (b) formed of metal. The scan electrode 102 and the sustain electrode 103 are covered with at least one dielectric layer 104, which controls a discharge current and insulates the paired electrodes. A protective layer 105 is formed of oxide magnesium (MgO) on the dielectric layer 104 to facilitate a discharge condition.

The rear substrate 110 comprises stripe-type (or well-type) barrier ribs 112 for forming a plurality of discharge spaces (that is, discharge cells) and arranged in parallel. Also, the rear substrate 110 comprises a plurality of address electrodes 113 arranged in parallel with the barrier ribs 112), and performing an address discharge and generating the vacuum ultraviolet rays. Red (R), green (G), blue (B) phosphors 114 emit visible rays for displaying the image in the address discharge, and are coated over an upper surface of the rear substrate 110. Lower dielectric layer 115 for protecting the address electrode 113 is formed between the address electrode 113 and the phosphor 114.

FIG. 2 illustrates a conventional method for expressing a gray level of the image in a plasma display apparatus.

As shown in FIG. 2, in the conventional method for expressing the image gray level in the plasma display apparatus, one frame is divided into several subfields having the different number of times of emission. Each subfield is divided into a reset period (RPD) for initializing all cells, an address period (APD) for selecting the discharge cell, and a sustain period (SPD) for expressing the gray level depending on the number of times of discharge. For example, when the image is displayed in 256 gray levels, as shown in FIG. 2, a frame period (16.67 ms) corresponding to a 1/60 second is divided into eight subfields (SF1 to SF8), and each of the eight subfields (SF1 to SF8) is divided into the reset period, the address period, and the sustain period.

The reset period and the address period of each subfield are the same at each subfield. The address discharge for selecting the cell to be discharged is generated by a voltage difference between the address electrode and the scan electrode being the transparent electrode. The sustain period is increased in a ratio of 2ⁿ (n=0,1,2,3,4,5,6,7) at each subfield. Since the sustain period is different at each subfield as described above, the sustain period of each subfield (that is, the number of times of sustain discharge) is controlled, thereby expressing the image gray level.

Meantime, in the conventional plasma display apparatus, as a driving waveform is applied at each of the divided reset period, address period, and sustain period, EMI is generated in front of the plasma display panel.

In particular, there is a drawback in that the EMI increases due to a current pecking component generated as a high frequency and high voltage sustain waveform is alternately applied to the scan electrode and the sustain electrode in the sustain period.

### SUMMARY OF THE INVENTION

Accordingly, an object of the present invention is to solve at least the problems and disadvantages of the background art.

An object of the present invention is to provide a plasma display apparatus capable of preventing electromagnetic interference (EMI) from being generated during a sustain period, and a driving method thereof.

To achieve these and other advantages and in accordance with the purpose of the present invention, as embodied and broadly described, there is provided plasma display apparatus including: a plasma display panel comprising a plurality of sustain electrode pairs; and a sustain waveform driver comprising a filter unit provided at a path for supplying a sustain waveform to at least any one electrode of the sustain electrode pairs.

In another aspect of the present invention, there is provided a plasma display apparatus comprising: a plasma display panel comprising a plurality of sustain electrode pairs; and a sustain waveform driver comprising a film capacitor provided at a path for supplying a sustain waveform to at least any one electrode of the sustain electrode pairs.

In a further another aspect of the present invention, there is provided a driving method of a plasma display apparatus for supplying a sustain waveform to a plurality of sustain electrode pairs, the method comprising the steps of: filtering and supplying energy to at least any one of the sustain electrode pairs; supplying a sustain voltage to the electrode following the supplying of the energy; filtering and recovering the energy from the electrode; and supplying a base voltage to the electrode after the recovering of the energy.

The inventive plasma display apparatus has an effect of being capable of reducing the EMI resulting from a high frequency component when the sustain waveform is applied.

### BRIEF DESCRIPTION OF THE DRAWINGS

The invention will be described in detail with reference to the following drawings in which like numerals refer to like elements.

FIG. 1 illustrates a constructoin of a conventional plasma display panel;

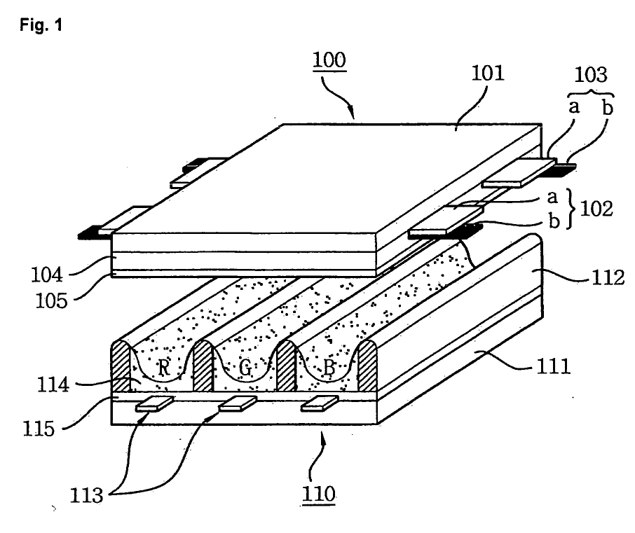

FIG. 2 illustrates a conventional method for expressing an image gray level of a plasma display apparatus;

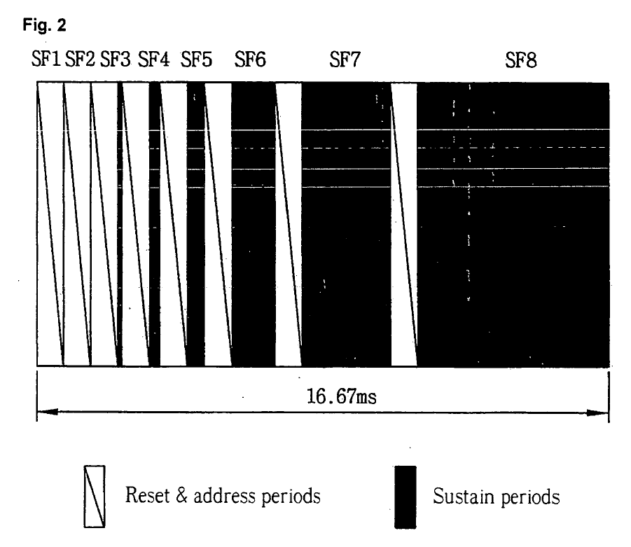

FIG. 3 illustrates a plasma display apparatus according to an embodiment of the present invention;

FIG. 4 illustrates a sustain waveform driver according to an embodiment of the present invention;

FIG. 5 illustrates a driving method of a plasma display apparatus according to an embodiment of the present invention; and

FIG. 6 illustrates a characteristic of EMI generated in driving a plasma display apparatus according to an embodiment of the present invention.

### DETAILED DESCRIPTION OF PREFERRED EMBODIMENTS

Preferred embodiments of the present invention will be described in a more detailed manner with reference to the drawings.

The inventive plasma display apparatus comprises: a plasma display panel comprising a plurality of sustain electrode pairs; and a sustain waveform driver comprising a filter unit provided at a path for supplying a sustain waveform to at least any one electrode of the sustain electrode pairs.

The sustain electrode pair comprises a scan electrode and a sustain electrode and the sustain waveform driver comprises a scan driver and a sustain driver.

The sustain waveform driver further comprises an energy recovery and supply unit for recovering energy generated in supplying the sustain waveform and again supplying the recovered energy to the plasma display panel.

The energy recovery and supply unit comprises: an inductor unit for supplying and recovering energy stored in an energy storage unit, to and from the sustain electrode pair through a supply path having a predetermined inductance; a sustain voltage supply controller for supplying the energy to the sustain electrode pair and supplying a sustain voltage; and a base voltage supply controller for recovering the energy from the sustain electrode pair and supplying a base voltage.

The filter unit is connected in parallel with an energy supply path for supplying the energy from a common terminal of the inductor unit and the sustain voltage supply controller to the sustain electrode pair.

The filter unit has a capacitance of 1000 pF to 4000 pF.

The filter unit filters a frequency band of about 30 MHz to 70 MHz.

The inventive plasma display apparatus comprises: a plasma display panel comprising a plurality of sustain electrode pairs; and a sustain waveform driver comprising a film capacitor provided at a path for supplying a sustain waveform to at least any one electrode of the sustain electrode pairs.

The sustain electrode pair comprises a scan electrode and a sustain electrode and the sustain waveform driver comprises a scan driver and a sustain driver.

The sustain waveform driver further comprises an energy recovery circuit for recovering energy generated in supplying the sustain waveform and again supplying the recovered energy to the plasma display panel.

The energy recovery circuit comprises: an inductor for supplying and recovering energy stored in an energy storage unit, to and from the sustain electrode pair through a supply path having a predetermined inductance; a sustain voltage supply control switch for supplying the energy to the sustain electrode pair and supplying a sustain voltage; and a base voltage supply control switch for recovering the energy from the sustain electrode pair and supplying a base voltage.

The film capacitor is connected in parallel with an energy supply path for supplying the energy from a common terminal of the inductor and the sustain voltage supply control switch to the sustain electrode pair.

The film capacitor has a capacitance of 1000 pF to 4000 pF.

More than one film capacitor is provided.

The film capacitor is varied in number with respect to a frequency band of current applied to the sustain electrode pair.

The film capacitors are provided in plural, the film capacitors are connected in series or in parallel with each other.

A connection relationship of the film capacitors is varied with respect to a frequency band of current applied to the sustain electrode pair.

The film capacitor filters a frequency band of about 30 MHz to 70 MHz.

In the inventive driving method of a plasma display apparatus for supplying a sustain waveform to a plurality of sustain electrode pairs, the method comprises the steps of: filtering and supplying energy to at least any one of the sustain electrode pairs; supplying a sustain voltage to the electrode following the supplying of the energy; filtering and recovering the energy from the electrode; and supplying a base voltage to the electrode after the recovering of the energy.

Any one of the supplied energy and the recovered energy is filtered at a frequency band of about 30 MHz to 70 MHz.

Hereinafter, the inventive plasma display apparatus will be in detail described with reference to the attached drawings.

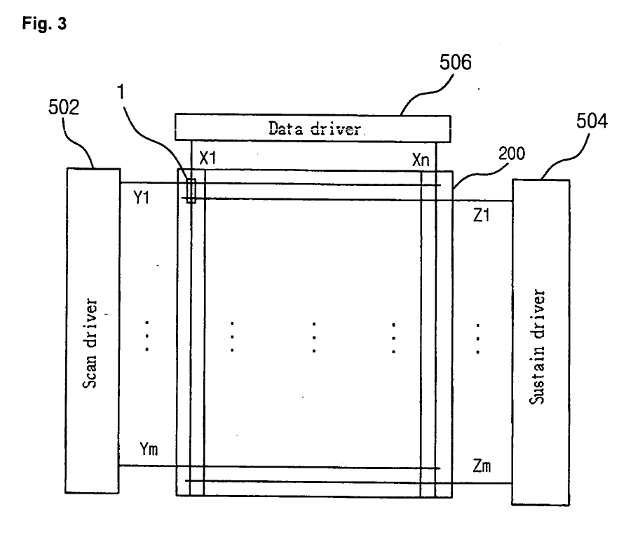

FIG. 3 illustrates a plasma display apparatus according to an embodiment of the present invention.

Referring to FIG. 3, the inventive plasma display apparatus comprises a plasma display panel 200, a scan driver 502, a sustain driver 504, and a data driver 506. In the present invention, a plurality of sustain electrode pairs comprises scan electrodes and sustain electrodes, and a sustain waveform driver for supplying a sustain waveform is divided as the scan driver 502 and the sustain driver 504 each driving each electrode.

The plasma display panel 200 is formed by sealing a front substrate (not shown) and a rear substrate (not shown). In the front substrate, scan electrode lines (Y1 to Ym) and sustain electrode lines (Z1 to Zm) are paired, and in the rear substrate, data electrode lines (X1 to Xn) are formed to intersect the scan electrode lines (Y1 to Ym) with the sustain electrode lines (Z1 to Zm) so that the number of m×n of discharge cells (1) are arrayed in matrix.

In the scan driver 502, a setup waveform and a setdown waveform are supplied to the scan electrode lines (Y1 to Ym) during a reset period, and a scan waveform falling from a scan reference voltage to a negative scan voltage is supplied to the scan electrode lines (Y1 to Ym) during an address period, and a sustain waveform swinging from a sustain voltage to a base voltage is supplied to the scan electrode lines (Y1 to Ym) during a sustain period.

In the sustain driver 504, a predetermined reference voltage is supplied to the sustain electrode lines (Z1 to Zm) during a setdown period or an address period, and the sustain waveform swinging from the sustain voltage to the base voltage is supplied to the sustain electrode lines (Z1 to Zm) to alternate with the sustain waveform supplied to the scan electrode lines (Y1 to Ym) during the sustain period.

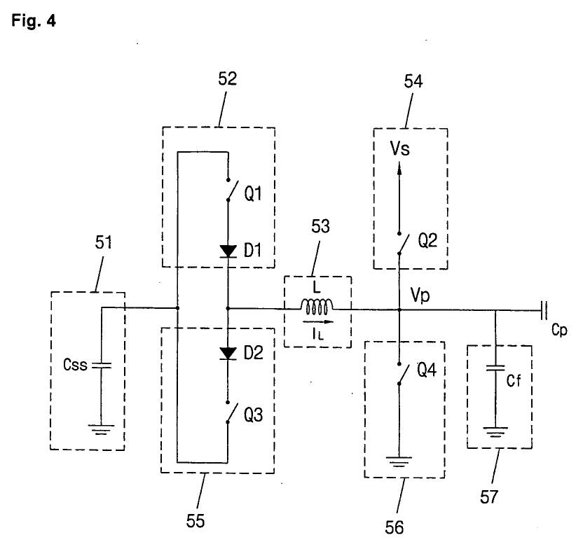

At least any one of the scan driver 502 or the sustain driver 504 according to an embodiment of the present invention comprises a filter unit on a path supplying the sustain waveform. Accordingly, a current pecking component generated when the sustain waveform is supplied can be reduced, thereby preventing generation of electromagnetic interference (EMI). A more detailed description thereof will be made with reference to FIGS. 4 to 6 below.

The data driver 506 supplies an address waveform based on image data to the address electrodes (X1 to Xm) in synchronization with the scan waveform during the address period.

In an embodiment of the present invention, as shown in FIG. 4, the sustain waveform driver, that is, the scan driver 502 and the sustain driver 504 comprises an energy recovery and supply unit constituted of an energy recovery circuit recovering and reusing energy supplied to the plasma display panel during the sustain period.

FIG. 4 illustrates the sustain waveform driver according to an embodiment of the present invention.

Referring to FIG. 4, the sustain waveform driver, for example, any one of the scan driver or the sustain driver comprises an energy recovery and supplying unit, and a filter unit 57. The energy recovery and supplying unit is comprised of an energy storage unit 51, an energy supply controller 52, an inductor unit 53, a sustain voltage supply controller 54, an energy recovery controller 55, and a base voltage supply controller 56.

The energy storage unit 51 includes a supply and recovery capacitor (Css) for storing energy necessary for a sustain discharge, and the supply and recovery capacitor (Css) has a terminal commonly connected with terminals of the energy supply controller 52 and the energy recovery controller 55.

The energy supply controller 52 comprises a first switch (Q1) and a first diode (D1). The first switch (Q1) is turned on to supply energy stored in the supply and recovery capacitor (Css) of the energy storage unit 51 to the plasma display panel (Cp). The first diode (D1) cuts off a reverse current flowing from the panel (Cp) to the supply and recovery capacitor (Css) via the first switch (Q1). The first diode (D1) has a cathode terminal connected to a terminal of a first inductor (L) of the inductor unit 53, and an anode terminal connected to a terminal of the first switch (Q1).

The inductor unit 53 comprises the inductor (L) constituting a series LC resonance circuit together with the plasma display panel (Cp). When the energy stored in the energy storage unit 51 is supplied to the plasma display panel (Cp) by the energy supply controller 52, the plasma display panel (Cp) begins to be charged with a resonance waveform supplied via the inductor unit 53, and is charged to the sustain voltage (Vs). Further, when energy of the plasma display panel (Cp) is recovered to the energy storage unit 53, a reactive power recovery path is formed depending on turn-on of a third switch (Q3). Accordingly, the energy storage unit 51 is charged with energy of a voltage component of the reactive power recovered via the inductor unit 53.

The sustain voltage supply controller 55 comprises a second switch (Q2) being a sustain voltage supply control switch for supplying energy to the sustain electrode pair of the plasma display panel (Cp) and sustaining the supplied energy as the sustain voltage. The second switch (Q2) has a terminal connected with an external sustain voltage source supplying a sustain voltage (Vs). The second switch (Q2) is turned on to allow the plasma display panel (Cp) to sustain the sustain voltage (Vs) when the energy supplied to the plasma display panel (Cp) becomes the sustain voltage (Vs).

The energy recovery controller 54 comprises a third switch (Q3) and a second diode (D2). The third switch (Q3) is turned on to allow the voltage component of the reactive power to be recovered to the supply and recovery capacitor (Css) of the energy storage unit 51. The second diode (D2) cuts off a reverse current flowing from the supply and recovery capacitor (Css) to the panel (Cp) via the third switch (Q3). The second diode (D2) has an anode terminal connected to a terminal of a second inductor (L2) of the inductor unit 53, and a cathode terminal connected to a terminal of the third switch (Q3).

The base voltage supply controller 56 comprises a fourth switch (Q4) being a base voltage supply control switch for recovering the supplied energy from the sustain electrode pair of the plasma display panel (Cp) and sustaining the recovered energy as the base voltage. The fourth switch (Q4) has a terminal connected with an external base voltage source (GND). After the energy storage unit 51 is charged with energy of Vs/2, the fourth switch (Q4) is turned on, thereby allowing the plasma display panel (Cp) to sustain a voltage value (0V) of the base voltage supplied from the base voltage source (GND).

The filter unit 57 a comprises film capacitor (Cf) for preventing the EMI from being generated by the sustain waveform supplied during the sustain period.

The filter unit 57 has a terminal connected in parallel with an energy supply path for supplying the energy from a common terminal of the inductor unit 53 and the sustain voltage supply controller 55, and has an internal film capacitor for filtering a pecking component of a high frequency current supplied to the plasma display panel (Cp).

The filter unit can include more than at least one film capacitor (Cf). The film capacitor (Cf) can be varied in number depending on a frequency band of current applied to the sustain electrode pair of the plasma display panel (Cp).

In case where the film capacitor (Cf) is provided in plural, they are connected in series or parallel depending on the frequency band of the current to be filtered. When it is intended to widen the frequency band of the current to be filtered, the film capacitors can be connected in parallel, and when it is intended to narrow the frequency band of the current to be filtered, the film capacitors can be connected in parallel.

This is because, when energy is supplied to the panel, a band gap of a resonance frequency is controlled depending on a capacitance of the film capacitor (Cf) and accordingly, the frequency band of the current to be filtered is controlled. At this time, the film capacitor has one tenth of the capacitance of the plasma display panel (Cp). Preferably, the film capacitor (Cf) according to an embodiment of the present invention has a capacitance of 1000 pF to 4000 pF.

The film capacitor (Cf) filters a frequency band of about 30 MHz to 70 MHz. This is because, during the sustain period, EMI is much generated in front of the plasma display panel at the frequency band of about 30 MHz to 70 MHz.

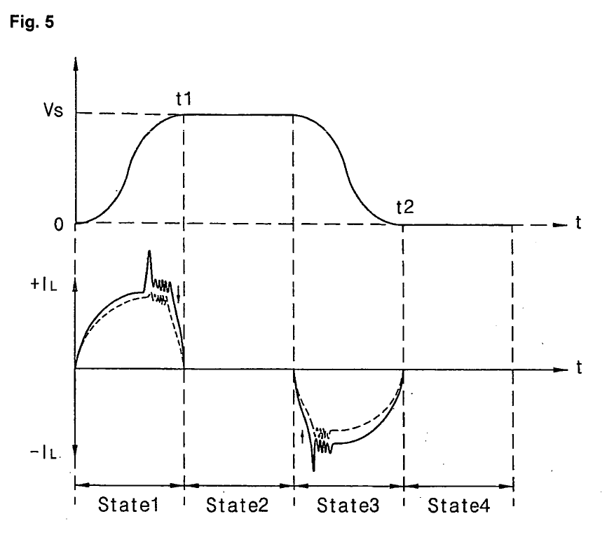

FIG. 5 illustrates a driving method of a plasma display apparatus according to an embodiment of the present invention.

In a description of FIG. 5 referring to the sustain waveform driver of FIG. 4, the plasma display apparatus is driven as in the following states.

In an energy supplying state (State 1), the first switch (Q1) is turned on, and remaining second to fourth switches (Q2, Q3, and Q4) are all turned off. Accordingly, the energy stored in the supply and recovery capacitor (Css) is supplied to the sustain electrode pair of the plasma display panel (Cp). The energy is supplied along a path having a sequence of the supply and recovery capacitor (Css), the first switch (Q1), the first diode (D1), the inductor unit 52, and the plasma display panel (Cp). At this time, the energy supplied to the plasma display panel (Cp), that is, the pecking component of the high frequency current being an EMI source is filtered. For example, it can be understood that, in the energy supplying state (State 1) of FIG. 5, the pecking component of the current (I_{L}) is filtered, thereby reducing the current (I_{L}) from a solid line to a dotted line.

In the sustain voltage sustaining state (State 2), the second switch (Q2) is turned on, and remaining first, third, and fourth switches (Q1, Q3, and Q4) are turned off. Accordingly, following the supplying of the energy, the sustain voltage (Vs) is applied and sustained to the plasma display panel (Cp), thereby sustaining a sustain discharge.

In an energy recovery state (State 3), the third switch unit (Q3) is turned on, and remaining first, second, and fourth switches (Q1, Q2, Q4) are turned off. Accordingly, a voltage component of the reactive power of the panel is recovered as energy to the supply and recovery capacitor (Css). The recovered energy follows a path having a sequence of the panel (Cp), the inductor unit 52, the second diode (D2), the third switch (Q3), and the supply and recovery capacitor (Css). At this time, the energy recovered from the plasma display panel (Cp), that is, the pecking component of the high frequency current being the EMI source is filtered. For example, it can be understood that, in the energy recovering state (State 3) of FIG. 5, the pecking component of the current (−I_{L}) is filtered, thereby reducing the current (−I_{L}) from a solid line to a dotted line.

In a base voltage sustaining and energy supplementing state (State 4), the fourth switch (Q4) is turned on, and the first and second switches (Q1 and Q2) are turned off. It does not matter that the third switch (Q3) is turned off or on. Accordingly, a voltage applied to the plasma display panel (Cp) is a ground level (GND).

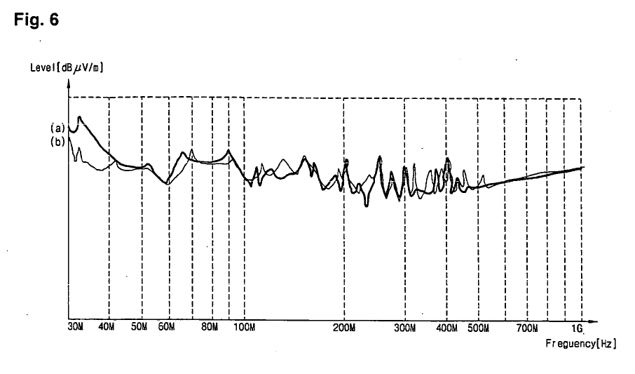

FIG. 6 illustrates a characteristic of EMI generated in driving the plasma display apparatus according to an embodiment of the present invention..

As shown in FIG. 6, a graph illustrates a level of the EMI depending on the frequency band. FIG. 6A illustrates a characteristic EMI generated in driving the conventional plasma display apparatus. FIG. 6B illustrates a characteristic of EMI generated in driving the inventive plasma display apparatus. Comparing FIGS. 6A and 6B, the inventive plasma display apparatus including the filter unit has a remarkably improved characteristic of EMI in comparison with the conventional plasma display apparatus.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a plasma display panel comprising a plurality of sustain electrode pairs; and
a sustain waveform driver comprising a filter unit provided at a path for supplying a sustain waveform to at least any one electrode of the sustain electrode pairs.

2. The apparatus of claim 1, wherein the sustain electrode pair comprises a scan electrode and a sustain electrode and the sustain waveform driver comprises a scan driver and a sustain driver.

3. The apparatus of claim 1, wherein the sustain waveform driver further comprises an energy recovery and supply unit for recovering energy generated in supplying the sustain waveform and again supplying the recovered energy to the plasma display panel.

4. The apparatus of claim 3, wherein the energy recovery and supply unit comprises:
an inductor unit for supplying and recovering energy stored in an energy storage unit, to and from the sustain electrode pair through a supply path having a predetermined inductance;
a sustain voltage supply controller for supplying the energy to the sustain electrode pair and supplying a sustain voltage; and
a base voltage supply controller for recovering the energy from the sustain electrode pair and supplying a base voltage.

5. The apparatus of claim 4, wherein the filter unit is connected in parallel with an energy supply path for supplying the energy from a common terminal of the inductor unit and the sustain voltage supply controller to the sustain electrode pair.

6. The apparatus of claim 1, wherein the filter unit has a capacitance of 1000 pF to 4000 pF.

7. The apparatus of claim 1, wherein the filter unit filters a frequency band of about 30 MHz to 70 MHz.

8. A plasma display apparatus comprising:
a plasma display panel comprising a plurality of sustain electrode pairs; and
a sustain waveform driver comprising a film capacitor provided at a path for supplying a sustain waveform to at least any one electrode of the sustain electrode pairs.

9. The apparatus of claim 8, wherein the sustain electrode pair comprises a scan electrode and a sustain electrode and the sustain waveform driver comprises a scan driver and a sustain driver.

10. The apparatus of claim 8, wherein the sustain waveform driver further comprises an energy recovery circuit for recovering energy generated in supplying the sustain waveform and again supplying the recovered energy to the plasma display panel.

11. The apparatus of claim 10, wherein the energy recovery circuit comprises:
an inductor for supplying and recovering energy stored in an energy storage unit, to and from the sustain electrode pair through a supply path having a predetermined inductance;
a sustain voltage supply control switch for supplying the energy to the sustain electrode pair and supplying a sustain voltage; and
a base voltage supply control switch for recovering the energy from the sustain electrode pair and supplying a base voltage.

12. The apparatus of claim 10, wherein the film capacitor is connected in parallel with an energy supply path for supplying the energy from a common terminal of the inductor and the sustain voltage supply control switch to the sustain electrode pair.

13. The apparatus of claim 8, wherein the film capacitor has a capacitance of 1000 pF to 4000 pF.

14. The apparatus of claim 8, Wherein more than one film capacitor is provided.

15. The apparatus of claim 14, the film capacitor is varied in number with respect to a frequency band of current applied to the sustain electrode pair.

16. The apparatus of claim 14, wherein the film capacitors are provided in plural, the film capacitors are connected in series or in parallel with each other.

17. The apparatus of claim 16, wherein a connection relationship of the film capacitors is varied with respect to a frequency band of current applied to the sustain electrode pair.

18. The apparatus of claim 7, wherein the film capacitor filters a frequency band of about 30 MHz to 70 MHz.

19. A driving method of a plasma display apparatus for supplying a sustain waveform to a plurality of sustain electrode pairs, the method comprising the steps of:
filtering and supplying energy to at least any one of the sustain electrode pairs;
supplying a sustain voltage to the electrode following the supplying of the energy;
filtering and recovering the energy from the electrode; and
supplying a base voltage to the electrode after the recovering of the energy.

20. The method of claim 19, wherein any one of the supplied energy and the recovered energy is filtered at a frequency band of about 30 MHz to 70 MHz.
